(19) United States
(12) Patent Application Publication
(10) Pub. No.: US 2009/0237330 A1
(43) Pub. Date: Sep. 24, 2009

(54) PLASMA DISPLAY DEVICE AND PLASMA-DISPLAY-PANEL DRIVING METHOD

(75) Inventors: Hidehiko Shoji, Osaka (JP); Takahiko Origuchi, Osaka (JP); Toshiyuki Maeda, Hyogo (JP); Mitsuo Ueda, Hyogo (JP); Takayuki Kamatani, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/092,102

(22) PCT Filed: Aug. 9, 2007
(86) PCT No.: PCT/JP2007/065582

§ 371 Date: Apr. 30, 2008

(30) Foreign Application Priority Data
Aug. 31, 2006 (JP) 2006-235210

(51) Int. Cl. G09G 3/28

(52) U.S. Cl. 345/60

(57) ABSTRACT

In a plasma display device, a period for connecting display electrode pairs to the base potential is disposed between a sustain pulse for generating the final sustain discharge and the previous sustain pulse based on a lighting ratio of the discharge cells in the corresponding subfield, and a voltage for reducing an interelectrode potential difference of the display electrode pairs is applied to the display electrode pairs in a predetermined time period corresponding to the lighting ratio of the discharge cells in the corresponding subfield after applying the sustain pulse for generating the final sustain discharge to the scan electrodes.

### TECHNICAL FIELD

The present invention relates to a plasma display device used in a wall-mounted television or a large-scaled monitor and a plasma-display-panel driving method.

### BACKGROUND ART

In an AC surface discharge panel representative of a plasma display panel (hereinafter, simply referred to as “panel”), plural discharge cells are formed between a front substrate and a rear substrate opposed to each other. In the front substrate, plural display electrode pairs each including a scan electrode and a sustain electrode are formed on a front glass substrate so as to be parallel to each other and a dielectric layer and a protective layer are formed to cover the display electrode pairs. In the rear substrate, plural parallel data electrodes are formed on a rear glass substrate, a dielectric layer is formed to cover the data electrodes, plural barrier ribs are formed thereon to be parallel to the data electrodes, and a phosphor layer is formed on the surface of the dielectric layer and on the side surfaces of the barrier ribs. The front substrate and the rear substrate are opposed to each other so that the display electrode pairs and the data electrodes three-dimensionally intersect each other and are sealed in this state. For example, a discharging gas including 5% of xenon in partial pressure ratio is enclosed in an inner discharge space. Here, discharge cells are formed at positions where the display electrode pairs and the data electrodes are opposed to each other. In the panel having the above-mentioned configuration, ultraviolet rays are generated in the discharge cells by a gaseous discharge and fluorescent substances of red (R), green (G), and blue (B) are excited to emit light by the ultraviolet rays, thereby performing a color display.

As a panel driving method, a subfield method, that is, a method of dividing a field period into plural subfields and performing a gray scale display by combinations of the subfields to emit light, is usually used.

Each subfield includes an initializing period, an address period, and a sustain period. In the initializing period, an initializing discharge is generated and wall charges necessary for a subsequent address operation are formed on the electrodes. An initializing operation includes an initializing operation (hereinafter, referred to as “overall cell initializing operation”) of generating an initializing discharge in all the discharge cells and an initializing operation (hereinafter, referred to as “selective initializing operation”) of generating the initializing discharge in only the discharge cells having generated the sustain discharge.

In the address period, an address discharge is generated to form wall charges by selectively applying an address pulse voltage to the discharge cells to be lighted (hereinafter, also referred to as “addressing”). In the sustain period, a sustain pulse voltage is alternately applied to the display electrode pairs each including a scan electrode and a sustain electrode and a sustain discharge is generated in the discharge cells having generated the address discharge to allow the phosphor layer of the corresponding discharge cells to emit light, thereby displaying an image.

The subfield method includes a new driving method of generating an initializing discharge by the use of a voltage waveform smoothly varying and selectively generating an initialing discharge in the discharge cells having generated the sustain discharge again, thereby greatly reducing the emission of light not associated with a gray scale display to improve a contrast ratio.

Specifically, an overall cell initializing operation of generating an initializing discharge in all the discharge cells is performed in the initializing period of one subfield among the plural subfields and a selective initializing operation of generating the initializing discharge in only the discharge cells having generated the sustain discharge is performed in the initializing period of the other subfields. As a result, the emission of light not associated with an image display includes only the emission of light associated with the discharge of the overall cell initializing operation and thus it is possible to display an image with high contrast (for example, see Patent Document 1).

According to this driving, the brightness of a black display area varying depending on the emission of light not associated with an image display is made by only the weak emission of light of the overall cell initializing operation, thereby displaying an image with high contrast.

Patent Document 1 discloses a so-called narrow erasing discharge in which the pulse width of the final sustain pulse in the sustain period is set to be smaller than the pulse width of the other sustain pulse so as to alleviate a potential difference due to the wall charges between the display electrode pairs. By stably generating the narrow erasing discharge, it is possible to reliably perform an address operation in an address period in the subsequent subfield and thus to provide a plasma display device with a high contrast ratio.

However, with an increase in precision, an increase in screen size, and an increase in brightness of a panel, the address discharge gets unstable. Accordingly, the address discharge may not be generated in the discharge cells to be lighted to deteriorate image display quality, or a voltage necessary for generating the address discharge may be raised.

Patent Document 1: Japanese Unexamined Patent Application Publication No. 2000-242224

### DISCLOSURE OF THE INVENTION

A plasma display device according to the invention includes: a panel that has a plurality of discharge cells having a plurality of scan electrodes and sustain electrodes which form display electrode pairs; and a driving circuit that drives the plasma display panel by dividing a field period into a plurality of subfields, each of which has an initializing period for generating an initializing discharge in the discharge cells, an address period for generating an address discharge in the discharge cells, and a sustain period for generating a sustain discharge in the discharge cells selected in the address period a number of times corresponding to a brightness weight, wherein the driving circuit alternately applies a sustain pulse varying from a base potential to a potential for generating the sustain discharge to the display electrode pairs, disposes a period for connecting the display electrode pairs to the base potential between a sustain pulse for generating the final sustain discharge and a previous sustain pulse, and applies a voltage for reducing an interelectrode potential difference of the display electrode pairs to the sustain electrodes in a predetermined time period after applying the sustain pulse for generating the final sustain discharge to the scan electrodes.

As a result, it is possible to generate a stable address discharge without increasing a voltage necessary for generating an address discharge.

### BRIEF DESCRIPTION OF THE DRAWINGS

FIG. 1 is an exploded perspective view illustrating a structure of a panel according to an embodiment of the invention.

FIG. 2 is a diagram illustrating an arrangement of electrodes in the panel.

FIG. 3 is a diagram schematically illustrating driving voltage waveforms, which show a configuration of subfields according to the embodiment of the invention.

FIG. 4 is a waveform diagram illustrating driving voltages applied to the electrodes of the panel according to the embodiment of the invention.

FIG. 5 is a partially enlarged diagram illustrating the waveforms of the driving voltages.

FIG. 6 is a diagram illustrating a relation between a lighting ratio and erasing phase difference Th1 and a relation between the lighting ratio and ground period ThG according to the embodiment of the invention.

FIG. 7A is a diagram schematically illustrating a relation between an address pulse voltage necessary for generating a stable address discharge and erasing phase difference Th1.

FIG. 7B is a diagram schematically illustrating a relation between a scan pulse voltage necessary for generating a stable address discharge and erasing phase difference Th1.

FIG. 8 is a diagram schematically illustrating a relation between the scan pulse voltage necessary for generating a stable address discharge and the lighting ratio.

FIG. 9 is a diagram illustrating a relation between the address pulse voltage necessary for generating a stable address discharge and ground period ThG according to the embodiment of the invention.

FIG. 10 is a diagram illustrating a relation between the scan pulse voltage necessary for generating a stable address discharge and ground period ThG according to the embodiment of the invention.

FIG. 11 is a diagram illustrating a relation between a voltage Ve2 necessary for generating a stable address discharge and the lighting ratio according to the embodiment of the invention.

FIG. 12 is a circuit block diagram illustrating a plasma display device according to the embodiment of the invention.

FIG. 13 is a circuit diagram illustrating a sustain pulse generating circuit according to the embodiment of the invention.

FIG. 14 is a timing diagram illustrating operations of the sustain pulse generating circuit according to the embodiment of the invention.

### DESCRIPTION OF REFERENCE NUMERALS AND SIGNS

1: PLASMA DISPLAY DEVICE
10: PANEL
21: FRONT SUBSTRATE
22: SCAN ELECTRODE
23: SUSTAIN ELECTRODE
24, 33: DIELECTRIC LAYER
25: PROTECTIVE LAYER
28: DISPLAY ELECTRODE PAIR
31: REAR SUBSTRATE
32: DATA ELECTRODE
34: BARRIER RIB
35: PHOSPHOR LAYER
51: IMAGE SIGNAL PROCESSING CIRCUIT
52: DATA ELECTRODE DRIVING CIRCUIT
53: SCAN ELECTRODE DRIVING CIRCUIT
54: SUSTAIN ELECTRODE DRIVING CIRCUIT
55: TIMING GENERATING CIRCUIT
58: LIGHTING RATIO CALCULATING CIRCUIT
100, 200: SUSTAIN PULSE GENERATING CIRCUIT
110, 210: POWER RECOVERING SECTION
120, 220: CLAMP SECTION
Q11, Q12, Q13, Q14, Q21, Q22, Q23, Q24, Q26, Q27, Q28, Q29: SWITCHING ELEMENT
D11, D12, D21, D22, D30: DIODE
C10, C20, C30: CAPACITOR
L10, L20: INDUCTOR
Cp: INTERELECTRODE CAPACITANCE
VE1, ΔVE, VS: POWER SOURCE

### DETAILED DESCRIPTION OF THE PREFERRED EMBODIMENTS

Hereinafter, a plasma display device according to an embodiment of the invention will be described with reference to the drawings.

### Embodiment

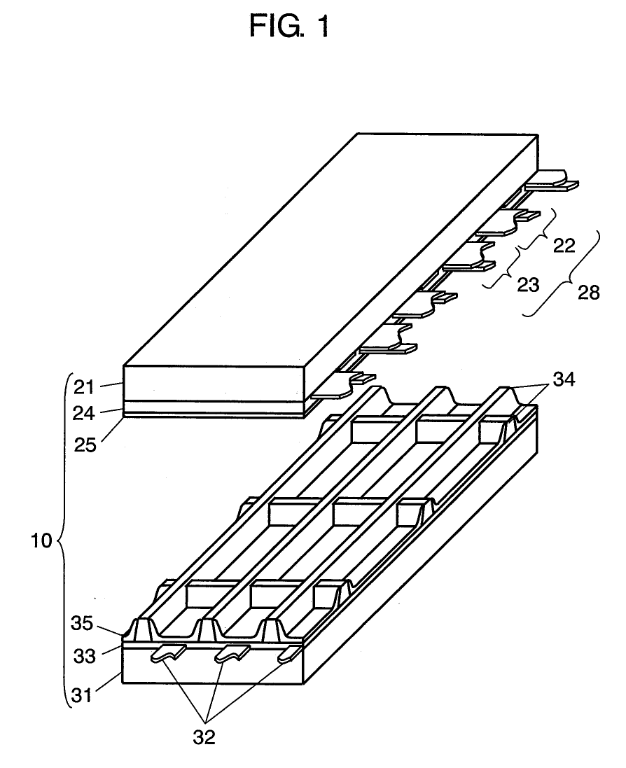

FIG. 1 is an exploded perspective view illustrating a structure of panel 10 according to an embodiment of the invention. Plural Display Electrode Pairs 28 Each Having Scan Electrode 22 and sustain electrode 23 are formed on front glass substrate 21. Dielectric layer 24 is formed to cover scan electrodes 22 and sustain electrodes 23 and protective layer 25 is formed on dielectric layer 24.

Plural data electrodes 32 are formed on rear substrate 31. Dielectric layer 33 is formed to cover data electrodes 32 and barrier ribs 34 having a “#” shape are formed thereon. Phosphor layers 35 emitting light of red (R), green (G), and blue (B) are formed on the side surfaces of barrier ribs 34 and on the surfaces of dielectric layer 33.

Front substrate 21 and rear substrate 31 are opposed to each other with a minute discharge space interposed therebetween so that display electrode pairs 28 and data electrodes 32 intersect each other and the outer circumferential portions thereof are sealed with a sealing material such as glass frit. A mixture gas of neon and xenon is enclosed as a discharging gas in the discharge space. The discharge space is partitioned into plural regions by barrier ribs 34 and discharge cells are formed at positions where display electrode pairs 28 and data electrodes 32 intersect each other. The discharge cells produce a discharge and emit light, thereby displaying an image.

The structure of the panel is not limited to the above-mentioned structure, but may have, for example, stripe-shaped barrier ribs.

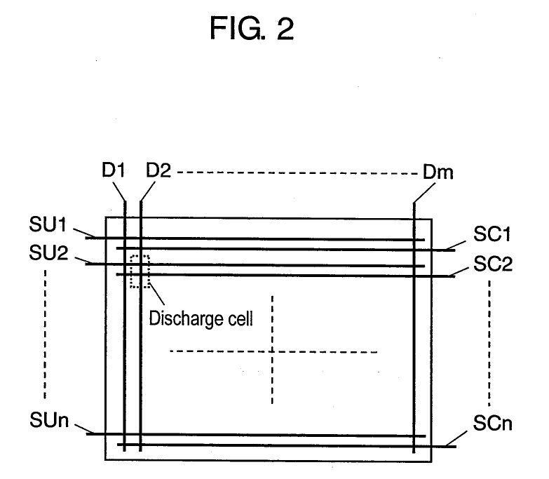

FIG. 2 is a diagram illustrating an arrangement of electrodes of panel 10 according to the embodiment of the invention. In panel 10, n scan electrodes SC1 to SCn (scan electrodes 22 in FIG. 1) and n sustain electrodes SU1 to SUn (sustain electrodes 23 in FIG. 1) which are longitudinal in the row direction are arranged and m data electrodes D1 to Dm (data electrodes 32 in FIG. 1) which are longitudinal in the column direction are arranged. A discharge cell is formed at a position where a pair of scan electrode SCi (i=1 to n) and sustain electrode SUi and one data electrode Dj (j=1 to m) intersect each other and thus m×n discharge cells in total are formed in the discharge space. As shown in FIGS. 1 and 2, since scan electrodes SCi and sustain electrodes SUi are formed parallel to each other to form pairs, great interelectrode capacitances Cp exist between scan electrodes SC1 to SCn and sustain electrodes SU1 to SUn.

Driving voltage waveforms for driving panel 10 and operations thereof will be described now. The plasma display device according to this embodiment performs a gray-scale display by the use of a subfield method, that is, by dividing a field period into plural subfields and controlling the emission and non-emission of light of the discharge cells by subfields. Each subfield has an initializing period, an address period, and a sustain period.

In the initializing period, an initializing discharge is generated to form wall charges necessary for a subsequent address discharge on the electrodes. This initializing operation includes an overall cell initializing operation of generating the initializing discharge in the overall discharge cells and a selective initializing operation of generating the initializing discharge in only the discharge cells having generated the sustain discharge in the previous subfield.

In the address period, the address discharge is selectively generated in the discharge cells which should emit light in the subsequent sustain period, thereby forming wall charges. In the sustain period, sustain pulses proportional to a brightness weight are alternately applied to display electrode pairs 28 and the sustain discharge is generated in the discharge cells having generated the address discharge to emit light. Here, the proportional coefficient is called “brightness magnification.”

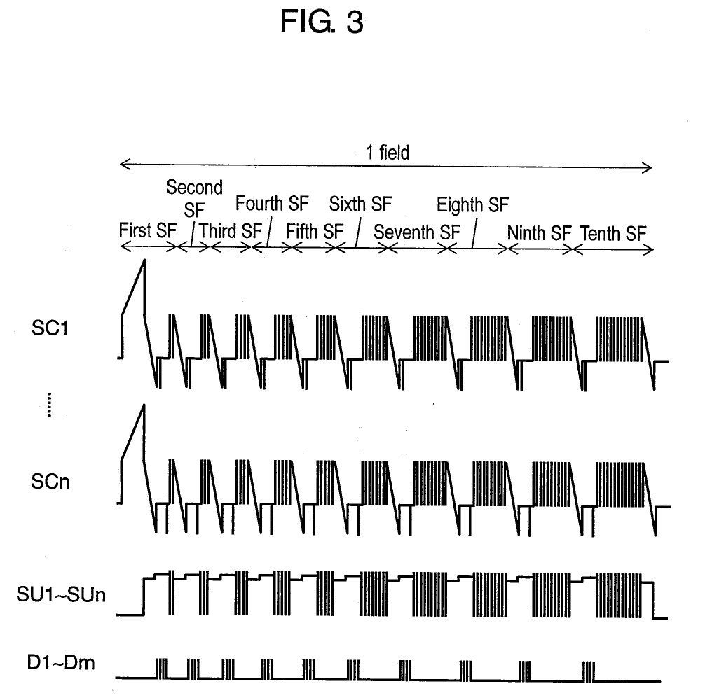

FIG. 3 is a diagram schematically illustrating driving waveforms of a subfield configuration according to the embodiment of the invention. FIG. 3 roughly shows driving voltage waveforms of a field in the subfield method and the driving voltage waveforms of the subfields are the same as the driving voltage waveforms described later.

In FIG. 3, the subfield configuration is shown in which a field is divided into 10 subfields (first SF, second SF, . . . , and tenth SF) and the subfields have brightness weights of, for example, 1, 2, 3, 6, 11, 18, 30, 44, 60, and 80, respectively. In this embodiment, the overall cell initializing operation is performed in the initializing period of the first SF and the selective initializing operation is performed in the initializing periods of the second SF to the tenth SF. In the sustain periods of the subfields, the sustain pulses corresponding to the number obtained by multiplying the brightness weights of the subfields by a predetermined brightness magnification are applied to the display electrode pairs.

In this embodiment, the number of subfields or the brightness weights of the subfields are not limited to the above-mentioned values, but the configuration of subfields may be changed based on the image signals or the like.

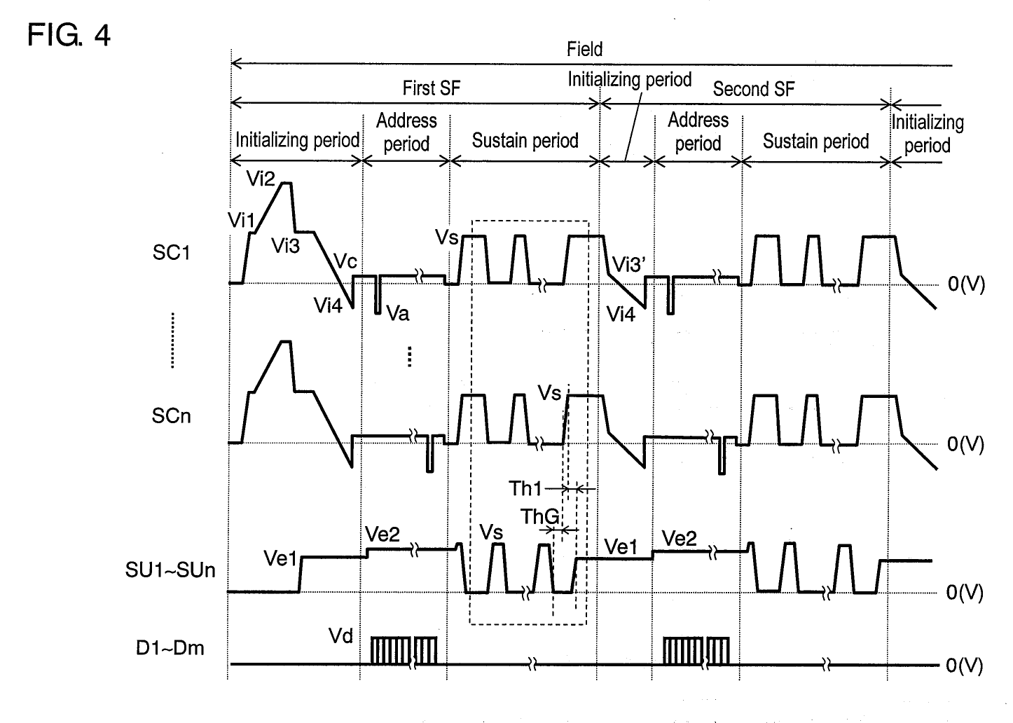

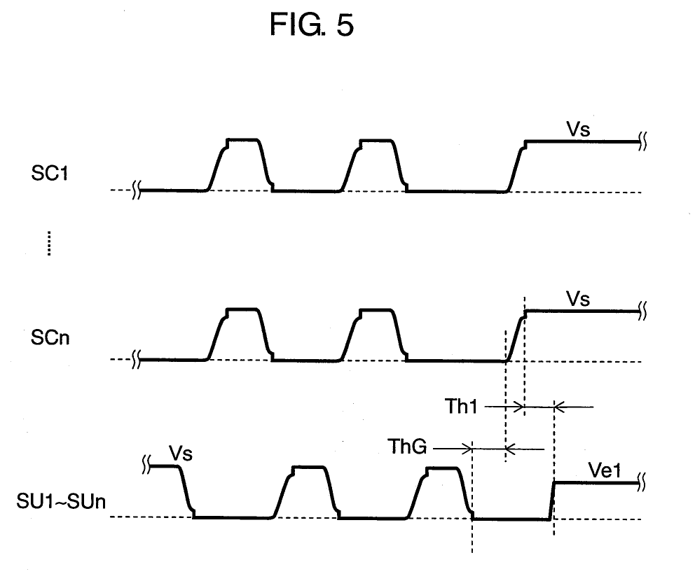

FIG. 4 is a waveform diagram illustrating driving voltages applied to the electrodes of panel 10 according to this embodiment of the invention. FIG. 5 is a partially enlarged diagram illustrating the waveforms of the driving voltages applied to the electrodes of panel 10 according to the embodiment of the invention. FIG. 4 shows driving voltage waveforms of two subfields, that is, a subfield (hereinafter, referred to as “overall cell initializing subfield”) in which the overall cell initializing operation is performed and a subfield (hereinafter, referred to as “selective initializing subfield”) in which the selective initializing operation is performed, but the driving voltage waveforms of the other subfields are the same subsequently. FIG. 5 is an enlarged diagram of the portion surrounded with the dotted line in FIG. 4 and shows the final portion of the sustain period.

The first SF which is the overall cell initializing subfield will be first described. In the first half of the initializing period of the first SF, 0 V is applied to data electrodes D1 to Dm and sustain electrodes SU1 to SUn and a ramp waveform voltage (hereinafter, referred to as “rising ramp waveform voltage”) slowly rising from voltage Vi1 which is equal to or smaller than a breakdown voltage for sustain electrodes SU1 to SUn to voltage V12 which is greater than the breakdown voltage is applied to scan electrodes SC1 to SCn.

While the rising ramp waveform voltage is rising, weak initializing discharge is generated between scan electrodes SC to SCn and sustain electrodes SU1 to SUn and data electrodes D1 to Dm. Negative wall voltages are accumulated on scan electrodes SC1 to SCn, and positive wall voltages are accumulated on data electrodes D1 to Dm and sustain electrodes SU1 to SUn. Here, the wall voltages on the electrodes mean voltages resulting from the wall charges accumulated on the dielectric layers, the protective layers, or the phosphor layers covering the electrodes.

In the second half of the initializing period, positive voltage Ve1 is applied to sustain electrodes SU1 to SUn and a ramp waveform voltage (hereinafter, referred to as “falling ramp waveform voltage”) slowly falling from voltage V13 which is equal to or smaller than the breakdown voltage for sustain electrodes SU1 to SUn to voltage Vi4 greater than the breakdown voltage is applied to scan electrodes SC1 to SCn. In the meantime, weak initializing discharge is generated between scan electrodes SC1 to SCn and sustain electrodes SU1 to SUn and data electrodes D1 to Dm. The negative wall voltage on scan electrodes SC1 to SCn and the positive wall voltage on sustain electrodes SU1 to SUn are weakened, whereby the positive wall voltage on data electrodes D1 to Dm are adjusted to a value suitable for the address operation. In this way, the overall cell initializing operation of generating the initializing discharge in the overall discharge cells is ended.

In the subsequent address period, voltage Ve2 is applied to sustain electrodes SU1 to SUn and voltage Vc is applied to scan electrodes SC1 to SCn.

First, negative scan pulse voltage Va is applied to scan electrode SC1 in the first row and positive address pulse voltage Vd is applied to data electrodes Dk (k=1 to m) of the discharge cells which should be lighted in the first row among data electrodes D1 to Dm. At this time, a voltage difference at an intersection between data electrode Dk and scan electrode Sc1 becomes a voltage obtained by adding a difference between the wall voltage of data electrode Dk and the wall voltage of scan electrode SC1 to externally applied voltage (Vd-Va), and thus becomes greater than the breakdown voltage. The address discharge is generated between data electrode Dk and scan electrode SC1 and between sustain electrode SU1 and scan electrode SC1, a positive wall voltage is accumulated on scan electrode SC1, a negative wall voltage is accumulated on sustain electrode SU1, and a negative wall voltage is accumulated on data electrode Dk.

In this way, the address operation of causing the address discharge in the discharge cells which should lighted in the first row and accumulating wall voltages on the electrodes is performed. On the other hand, since voltages of intersections between data electrodes D1 to Dm not supplied with address pulse voltage Vd and scan electrode SC1 do not exceed the breakdown voltage, the address discharge is not generated. The address operation is sequentially performed up to the discharge cells in the n-th row and the address period is finished.

In the subsequent sustain period, positive sustain pulse voltage Vs is applied to scan electrodes SC1 to SCn and a ground potential as a base potential, that is, 0 (V) is applied to sustain electrodes SU1 to SUn. Then, in the discharge cells having generated the address discharge in the previous address period, the voltage difference between scan electrode SCi and sustain electrode SUi becomes a voltage obtained by adding a difference between the wall voltage of scan electrode SCi and the wall voltage of sustain electrode SUi to sustain pulse voltage Vs and thus exceeds the breakdown voltage.

The sustain discharge is generated between scan electrode SCi and sustain electrode SUi and phosphor layer 35 emits light due to the ultraviolet rays created at that time. A negative wall voltage is accumulated on scan electrode SCi and a positive wall voltage is accumulated on sustain electrode SUi. A positive wall voltage is accumulated on data electrode Dk. In the discharge cells not having generated the address discharge in the address period, the sustain discharge is not generated and the wall voltage at the end of the initializing period is maintained.

Subsequently, 0 (V) as the base potential is applied to scan electrodes SC1 to SCn and sustain pulse voltage Vs is applied to sustain electrodes SU1 to SUn. Then, in the discharge cells having generated the sustain discharge, since the voltage difference between sustain electrode SUi and scan electrode SCi exceeds the breakdown voltage, the sustain discharge is generated again between sustain electrode SUi and scan electrode SCi, whereby a negative wall voltage is accumulated on sustain electrode SUi and a positive wall voltage is accumulated on scan electrode SCi. Similarly, by alternately applying the sustain pulses corresponding to the number obtained by multiplying the brightness weights by the brightness magnification to scan electrodes SC1 to SCn and sustain electrodes SU1 to SUn to cause a potential difference between the electrodes of the display electrode pairs, the sustain discharge is continuously generated in the discharge cells having generated the address discharge in the address period.

As shown in FIG. 5, at the last of the sustain period, voltage Ve1 is applied to sustain electrodes SU1 to SUn in a predetermined time Th1 after voltage Vs is applied to scan electrodes SC1 to SCn. Accordingly, a potential difference of a so-called narrow pulse shape is applied between scan electrodes SC1 to SCn and sustain electrodes SU1 to SUn and with positive wall charges left on data electrode Dk, a part or all of the wall voltages on scan electrode SCi and sustain electrode SUi are erased.

Specifically, sustain pulse voltage Vs is applied to scan electrodes SC1 to SCn in a period (hereinafter, referred to as “ground period ThG”) for connecting sustain electrodes SU1 to SUn and scan electrodes SC1 to SCn to 0 (V) after sustain electrodes SU1 to SUn are returned to 0 V as the base potential.

Then, in the discharge cells having generated the sustain discharge, the sustain discharge is generated between sustain electrode SUi and scan electrode SCi. Before the discharge is over, that is, while charge particles created due to the discharge sufficiently remain in the discharge space, voltage Ve1 is applied to sustain electrodes SU1 to SUn. Accordingly, the potential difference between sustain electrode SUi and scan electrode SCi is weakened to (Vs-Ve1). Then, with positive wall charges left on data electrode Dk, the wall voltages between scan electrodes SC1 to SCn and sustain electrodes SU1 to SUn are weakened to the difference (Vs-Ve1) between voltages applied to the electrodes. Hereinafter, this discharge is referred to as “erasing discharge.” The potential difference applied between the electrodes of the display electrode pairs, that is, between scan electrodes SC1 to SCn and sustain electrodes SU1 to SUn, so as to generate the erasing discharge is a potential difference having a narrow pulse shape with a small pulse width.

In this way, in a predetermined time period (hereinafter, referred to as “erasing phase difference Th1”) after voltage Vs for generating the final sustain discharge, that is, the erasing discharge, is applied to scan electrodes SC1 to SCn, voltage Ve1 for reducing the potential difference between the electrodes of the display electrode pairs is applied to sustain electrodes SU1 to SUn. In this way, the sustain operation in the sustain period of the first SF is finished.

Operations in the second SF which is the selective initializing subfield will be described.

In the selective initializing period of the second SF, in a state where voltage Ve1 is applied to sustain electrodes SU1 to SUn and 0 V is applied to data electrodes D1 to Dm, a falling ramp waveform voltage slowly falling from voltage Vi3′ to voltage Vi4 is applied to scan electrodes SC1 to SCn.

Then, in the discharge cells having generating the sustain discharge in the sustain period of the previous subfield, a weak initializing discharge is generated and the wall voltages of scan electrode SCi and sustain electrode SUi are weakened. As for data electrode Dk, since the positive wall voltage is sufficiently accumulated on data electrode Dk due to the previous sustain discharge, the excessive wall voltage is discharged and thus the wall voltage is adjusted to be suitable for the address operation.

On the other hand, in the discharge cells not having generated the sustain discharge in the previous subfield, the wall charges at the end of the initializing period of the previous subfield are maintained without being discharged. In this way, the selective initializing operation is an initializing operation of selectively generating the initializing discharge in the discharge cells having performed the sustain operation in the sustain period of the previous subfield.

Operations of the subsequent address period are similar to operations of the address period of the overall cell initializing subfield and thus will not be described. Operations of the subsequent sustain period are similar, except for the number of sustain pulses. The operations of the initializing periods of the third SF to the tenth SF are the same selective initializing operation as the second SF and the address operations of the address periods are similar to those of the second SF.

Here, in this embodiment, erasing phase difference Th1 of a voltage applied to display electrode pairs 28 at the final sustain discharge of the sustain period and ground period ThG in which display electrode pairs 28 are maintained at the ground potential as the base potential just before the erasing phase difference are controlled in accordance with a lighting ratio (a ratio of the number of lighted discharge cells to the total number of discharge cells) of each subfield.

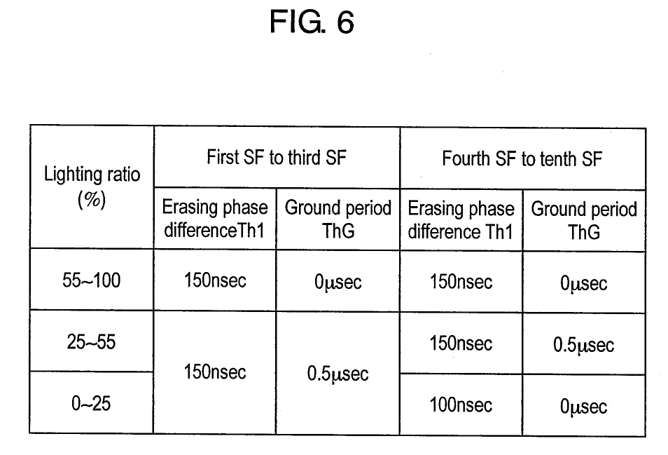

FIG. 6 is a diagram illustrating a relation between a lighting ratio and an erasing phase difference Th1 and a relation between the lighting ratio and a ground period ThG according to the embodiment of the invention. As shown in FIG. 6, in this embodiment, the ground period ThG is changed based on the comparison result between the lighting ratio of the corresponding subfield and a first predetermined threshold value (55% in this embodiment). In a subfield (subfield having a brightness weight of “5” or more in this embodiment) having a brightness weight greater than a predetermined brightness weight, the erasing phase difference Th1 and the ground period ThG are changed based on the comparison result between the lighting ratio of the subfield and a second threshold value (25% in this embodiment) smaller than the first threshold value.

Specifically, in the subfields (the first SF to the third SF which are subfields having a brightness weight less than “5” in this embodiment) having a relative small brightness weight, erasing phase difference Th1 is set to 150 nsec and ground period ThG is set to 0 μsec at the lighting ratio of 55% or more. Erasing phase difference Th1 is set to 150 nsec and ground period ThG is set to 0.5 μsec at the lighting ratio less than 55%.

In the subfields (the fourth SF to the tenth SF which are subfields having a brightness weight of “5” or more in this embodiment) having a relative large brightness weight, erasing phase difference Th1 is set to 150 nsec and ground period ThG is set to 0 μsec at the lighting ratio of 55% or more. Erasing phase difference Th1 is set to 150 nsec and ground period ThG is set to 0.5 μsec at the lighting ratio equal to or greater than 25% and less than 55%. Erasing phase difference Th1 is set to 100 nsec and ground period ThG is set to 0 μsec at the lighting ratio less than 25%.

In this embodiment, ground period ThG is changed based on the comparison result of the lighting ratio of the corresponding subfield with a predetermined first threshold value (55% in this embodiment). In addition, in the fourth SF to the tenth SF having a relatively large brightness weight, erasing phase difference Th1 and ground period ThG are changed based on the comparison result of the lighting ratio of the corresponding subfield with a second threshold value (25% in this embodiment) smaller than the first threshold value. This is because of the followings.

As described above, the erasing discharge with the narrow pulse forms desired wall charges by changing the electric field in the discharge space while charged particles produced by the discharge sufficiently remain in the discharge space and rearranging the charged particles to reduce the changed electric field to form the wall charges. That is, in the period of erasing phase difference Th1 after applying a voltage for generating the final sustain discharge, it is possible to generate a stable address discharge without increasing the scan pulse voltage or the address pulse voltage by applying the voltage for reducing the interelectrode potential difference of the display electrode pairs 28.

However, when erasing phase difference Th1 becomes greater, the charged particles generated due to the discharge are recombined and thus the charged particles for reducing the electric field is insufficient, thereby not forming the desired wall charges. As a result, it is found that address failure (hereinafter, referred to as “first type of address failure”) that the address discharge is not generated in the discharge cells to be discharged in the subsequent address period increases.

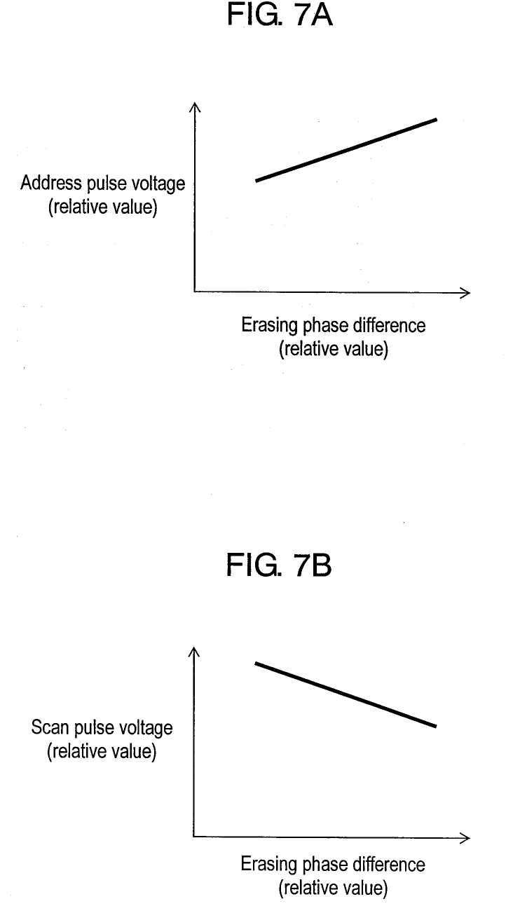

FIG. 7A is a diagram schematically illustrating a relation between the address pulse voltage necessary for generating a stable address discharge and erasing phase difference Th1. In the figure, the horizontal axis represents erasing phase difference Th1 and the vertical axis represents the address pulse voltage necessary for generating the stable address discharge. As shown in the figure, as erasing phase difference Th1 becomes greater, it is found that the necessary address pulse voltage increases so as to satisfactorily generate the address discharge in the discharge cells to be discharged.

On the other hand, when erasing phase difference Th1 is too small, it is found that the scan pulse voltage necessary for generating the stable address discharge increases. When the scan pulse voltage necessary for generating the stable address discharge and the scan pulse voltage to be applied actually is smaller than the necessary scan pulse voltage, the wall charges in the discharge cells not selected are removed while the address discharge is being generated in the discharge cells in one row. Then, when it is intended to generate the address discharge, there occurs address failure (hereinafter, referred to as “second type of address failure”) that the wall voltage is insufficient and thus the address discharge is not generated.

FIG. 7B is a diagram schematically illustrating a relation between the scan pulse voltage necessary for generating a stable address discharge and erasing phase difference Th1. In the figure, the horizontal axis represents erasing phase difference Th1 and the vertical axis represents the scan pulse voltage necessary for generating the stable address discharge. As shown in the figure, as erasing phase difference Th1 becomes smaller, it is found that the necessary scan pulse voltage increases.

In this way, the address pulse voltage necessary for generating the stable address discharge and the scan pulse voltage necessary for generating the stable address discharge represent a trade-off characteristic with respect to erasing phase difference Th1. Accordingly, when erasing phase difference Th1 is set to be smaller, the necessary address pulse voltage can be reduced but the necessary scan pulse voltage is increased, thereby easily causing the second type of address failure. On the contrary, when erasing phase difference Th1 is set to be greater, the necessary scan pulse voltage can be reduced but the necessary address pulse voltage is increased, thereby easily causing the first type of address failure.

In this way, since the first type of address failure and the second type of address failure represent the trade-off characteristic with respect to erasing phase difference Th1, it is practically preferable that erasing phase difference Th1 is set to a value not causing any address failure. As a result, it is possible to generate the stable address discharge without increasing the scan pulse voltage or the address pulse voltage. In order to reduce any address failure of the first type of address failure and the second type of address failure to realize the stable address discharge, it was found from an experiment that erasing phase difference Th1 is preferably set to 100 to 150 nsec.

It was found from the further study that optimal erasing phase difference Th1 becomes greater as the lighting ratio of the subfield becomes higher.

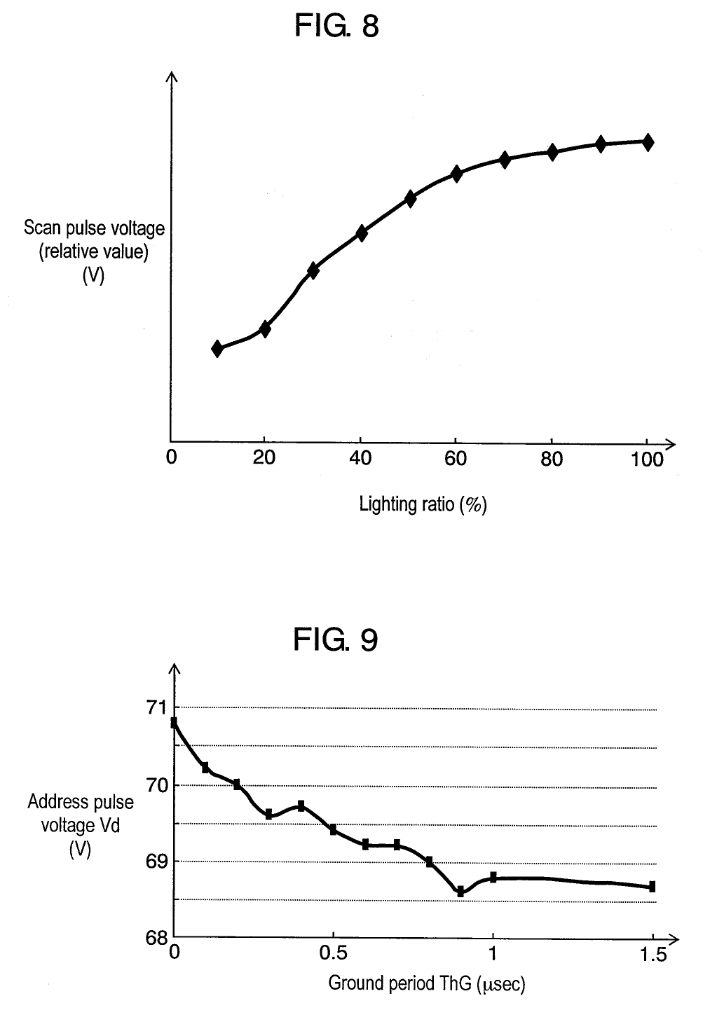

FIG. 8 is a diagram schematically illustrating a relation between the scan pulse voltage necessary for generating a stable address discharge and a lighting ratio. In the figure, the horizontal axis represents the lighting ratio and the vertical axis represents the scan pulse voltage necessary for generating the stable address discharge.

In panel 10, the discharge current increases with an increase in lighting ratio and the voltage drop thus increases, thereby lowering the effective voltage applied to the discharge cells. Accordingly, as shown in FIG. 8, when the lighting ratio increases, the scan pulse voltage necessary for generating the stable address discharge increases accordingly. That is, when the scan pulse voltage applied in practice is constant regardless of the lighting ratio, the effective voltage applied to the discharge cells is lowered with an increase in lighting ratio, thereby delaying the generation of the discharge. At this time, when the generation of the discharge is delayed, the width of the narrow potential difference for generating the erasing discharge is equivalently reduced. That is, the discharge is generated as if erasing phase difference Th1 decrease. Accordingly, in the subfield with a high lighting ratio, optimal erasing phase difference Th1 is greater than that of the subfield with a low lighting ratio.

It was found from the experiment, it is effective that erasing phase difference Th1 is set to 150 nsec at a high lighting ratio and erasing phase difference Th1 is set to 100 nsec at a low lighting ratio.

These numerical values are based on the characteristics of the 50-inch panel with 1080 display electrode pairs and show only examples of this embodiment. This embodiment is not limited to the numerical values, but the optimal values may be preferably set depending on the characteristics of the panel or specifications of the plasma display device.

Next, ground period ThG will be described. FIG. 9 is a diagram schematically illustrating a relation between the address pulse voltage Vd necessary for generating a stable address discharge and ground period ThG according to the embodiment of the invention. Here, the horizontal axis represents ground period ThG and the vertical axis represents the address pulse voltage Vd necessary for generating the stable address discharge. As shown in the figure, when ground period ThG is in the range of 0 to 1 μsec, it was found that address pulse voltage Vd necessary for generating the stable address discharge can be reduced with an increase in ground period ThG. This is because the state of the wall charges formed due to the sustain discharge just before the erasing discharge varies with a variation in ground period ThG. When ground period ThG is equal to or greater than 1 μsec, it was also found that the variation is also reduced.

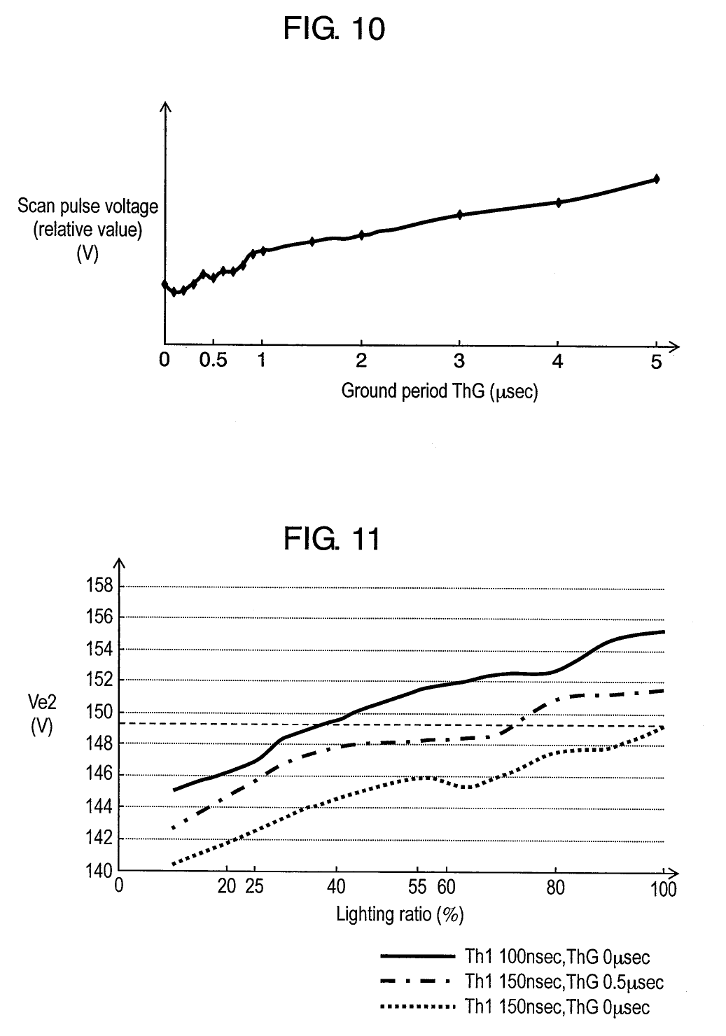

FIG. 10 is a diagram schematically illustrating a relation between the scan pulse voltage necessary for generating a stable address discharge and ground period ThG. In the figure, the horizontal axis represents ground period ThG and the vertical axis represents the scan pulse voltage necessary for generating the stable address discharge. As shown in FIG. 10, it was found that the scan pulse voltage necessary for generating the stable address discharge increases with an increase in ground period ThG, oppositely to the characteristic shown in FIG. 9. When ground period ThG is in the range of 0 to 0.5 μsec, the variation in necessary scan pulse voltage is negligible in practice.

In this way, the necessary address pulse voltage and the necessary scan pulse voltage represent the trade-off characteristic with respect to ground period ThG. When ground period ThG is in the range of 0 to 0.5 μsec, the variation of the necessary scan pulse voltage is negligible in practice. Accordingly, by setting ground period ThG to the range, it is possible to reduce the necessary address pulse voltage without increasing the necessary scan pulse voltage. As a result, in this embodiment, it is effective that ground period ThG is set to 0.5 μsec.

These numerical values are based on the characteristics of the 50-inch panel with 1080 display electrode pairs and show only examples of this embodiment. This embodiment is not limited to the numerical values, but the optimal values may be preferably set depending on the characteristics of the panel or specifications of the plasma display device.

On the other hand, the voltage value of positive voltage Ve2 applied to sustain electrodes SU1 to SUn in the address period and required to generate the stable address discharge varies by combinations of erasing phase difference Th1 and ground period ThG.

FIG. 11 is a diagram illustrating a relation between voltage Ve2 necessary for generating a stable address discharge and the lighting ratio according to the embodiment of the invention. In the figure, the horizontal axis represents the lighting ratio and the vertical axis represents voltage Ve2 necessary for generating the stable address discharge. By three combinations where erasing phase difference Th1 is 100 nsec and ground period ThG is 0 μsec, where erasing phase difference Th1 is 150 nsec and ground period ThG is 0.5 μsec, and where erasing phase difference Th1 is 150 nsec and ground period ThG is 0 μsec, the experiment was made. In the figure, the solid line represents the case where erasing phase difference Th1 is 100 nsec and ground period ThG is 0 μsec, the dot-chain line represents the case where when erasing phase difference Th1 is 150 nsec and ground period ThG is 0.5 μsec, and the dotted line represents the case where erasing phase difference Th1 is 150 nsec and ground period ThG is 0 μsec.

A combination where erasing phase difference Th1 is 100 nsec and ground period ThG is 0.5 μsec can be considered. However, in this combination, since the necessary scan pulse voltage increases, this combination is not used in this embodiment.

As shown in the figure, necessary voltage Ve2 is the highest at any lighting ratio when erasing phase difference Th1 is 100 nsec and ground period ThG is 0 μsec, is low when erasing phase difference Th1 is 150 nsec and ground period ThG is 0.5 μsec, and is the lowest when erasing phase difference Th1 is 150 nsec and ground period ThG is 0 μsec. In any combination, necessary voltage Ve2 increases with an increase in lighting ratio.

Therefore, in this embodiment, at the lighting ratio of 100% where necessary voltage Ve2 is the highest, the voltage value of voltage Ve2 in the combination of erasing phase difference Th1 and ground period ThG where necessary voltage Ve2 is the lowest is defined as the upper limit and the combination of erasing phase different Th1 and ground period ThG is changed depending on the lighting ratio so as not to exceed the voltage value.

That is, when the lighting ratio is high (when the lighting ratio is 55% or more in consideration of non-uniformity in panel characteristic and the temperature characteristic), erasing phase difference Th1 is set to 150 nsec and ground period ThG is set to 0 μsec so as to control necessary voltage Ve2 to the lowest. When the lighting ratio is middle (when the lighting ratio is 25% or more and less than 55%), necessary voltage Ve2 is decreased with the decrease of the lighting ratio. Accordingly, erasing phase difference Th1 is set to 150 nsec and ground period ThG is set to 0.5 μsec, so as to enhance the effect of reducing the necessary address pulse voltage. When the lighting ratio is low (when the lighting ratio is less than 25%), necessary voltage Ve2 is decreased with the decrease of the lighting ratio. Accordingly, erasing phase difference Th1 is set to 100 nsec and ground period ThG is set to 0 μsec, so as to enhance the effect of reducing the necessary address pulse voltage the most.

As a result, it is possible to control erasing phase difference Th1 and ground period ThG corresponding to the lighting ratio without exceeding the voltage value set as the upper limit of necessary voltage Ve2 (when the voltage value of voltage Ve2 when erasing phase difference Th1 is 150 nsec and ground period ThG is 0 μsec and when the lighting ratio is 100%) and to reduce the necessary address pulse voltage and the necessary scan pulse voltage, thereby generating the stable address discharge.

On the other hand, when the erasing discharge is generated, the weak emission of light due to the erasing discharge is caused. When erasing phase difference Th1 is 100 nsec and 150 nsec, a slight difference in emission intensity occurs due to the time difference until the discharge is weakened. This difference causes no problem in practice, but the difference may be recognized as a difference in brightness when a dark image low in APL, that is, when an image in which light is emitted in only the subfields having a small brightness weight.

Therefore, in this embodiment, in order to reduce the difference in brightness, erasing phase difference Th1 is not set to 100 nsec in the subfields (first SF to third SF of which the brightness weight is less than “5” in this embodiment) having a small brightness weight. Accordingly, even when an image low in APL in which only the subfields having a small brightness weight emit light, it is possible to display an image with a smooth variation in gray scale.

In the first SF to third SF having a small brightness weight, since the number of sustain pulses in the sustain period of the subfields is small, the priming generated at the time of generating the sustain discharge is reduced. When the priming formed in the sustain discharge is great, the increase in priming causes an increase in dark current, thereby enhancing the loss of wall charges, which is called charge reduction resulting from the dark current. However, in the first SF to third SF having a small brightness weight, since the priming generated in the sustain discharge is small, the loss of wall charges is small. Accordingly, even when erasing phase difference Th1 is not set to 100 nsec, it is possible to generate a stable address discharge.

That is, in this embodiment, when the lighting ratio is high (when the lighting ratio is 55% or more), erasing phase difference Th1 is set to 150 nsec and ground period ThG is set to 0 μsec in all the subfields. When the lighting ratio is middle (when the lighting ratio is 25% or more and less than 55%), erasing phase difference Th1 is set to 150 nsec and ground period ThG is set to 0.5 μsec in all the subfields. When the lighting ratio is low (when the lighting ratio is less than 25%), erasing phase difference Th1 is set to 100 nsec and ground period ThG is set to 0 μsec in only the subfields (the fourth SF to the tenth SF) having a predetermined brightness weight (brightness weight of “5”). In the subfields (the first SF to third SF) having a brightness weight less than it, erasing phase difference Th1 is not set to 100 nsec and ground period ThG is not set to 0 μsec even when the lighting ratio is less than 25%, but erasing phase difference Th1 is set to 150 nsec and ground period ThG is set to 0.5 μsec, similarly to the case where the lighting ratio is 25% or more and less than 55%.

As a result, according to this embodiment, it is possible to generate a stable address discharge without increasing the scan pulse voltage or the address pulse voltage necessary for generating the address discharge. In addition, it is possible to display an image low in APL with a smooth variation in gray scale.

The above-mentioned numerical values are based on the characteristics of the 50-inch panel with 1080 display electrode pairs and show only examples of this embodiment. This embodiment is not limited to the numerical values, but the optimal values may be preferably set depending on the characteristics of the panel or specifications of the plasma display device.

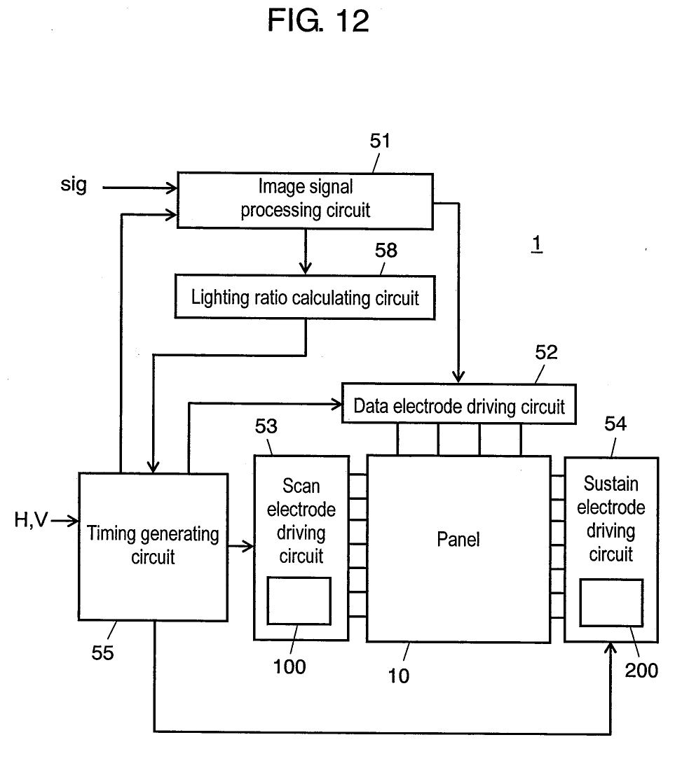

Next, a configuration of the plasma display device according to this embodiment will be described. FIG. 12 is a circuit block diagram illustrating the plasma display device according to the embodiment of the invention. Plasma display device 1 includes panel 10, image signal processing circuit 51, data electrode driving circuit 52, scan electrode driving circuit 53, sustain electrode driving circuit 54, timing generating circuit 55, lighting ration calculating circuit 58, and a power supply circuit (not shown) for supplying power to the circuit blocks.

Image signal processing circuit 51 converts input image signal sig into image data indicating emission or non-emission of light every subfield.

Lighting ratio calculating circuit 58 calculates a lighting ratio of the discharge cells for each subfield, that is, a ratio of the number of lighted discharge cells to the total number of discharge cells, based on image data for each subfield.

Timing generating circuit 55 generates various timing signals for controlling operations of the circuit blocks based on horizontal synchronization signal H, vertical synchronization signal V, and the lighting ratio calculated by lighting ratio calculating circuit 58 and supplies the generated timing signals to the circuit blocks. As described above, in this embodiment, when the lighting ratio is 55% or more, erasing phase difference Th1 is set to 150 nsec and ground period ThG is set to 0 μsec in all the subfields. When the lighting ratio is 25% or more and less than 55%, erasing phase difference Th1 is set to 150 nsec and ground period ThG is set to 0.5 μsec in all the subfields. When the lighting ratio is less than 25%, erasing phase difference Th1 is set to 100 nsec and ground period ThG is set to 0 μsec in only the fourth SF to the tenth SF. The corresponding timing signals are output to scan electrode driving circuit 53 and sustain electrode driving circuit 54. Accordingly, it is possible to control the address operation to be stable while smoothing the variation in gray scale of an image low in APL.

Data electrode driving circuit 52 converts image data of each subfield into signals corresponding to data electrodes D1 to Dm and drives data electrodes D1 to Dm.

Scan electrode driving circuit 53 includes sustain pulse generating circuit 100 and supplies driving voltage waveforms to scan electrodes SC1 to SCn based on the timing signals. Sustain electrode driving circuit 54 includes sustain pulse generating circuit 200 and supplies driving voltage waveforms to sustain electrodes SU1 to SUn based on the timing signals.

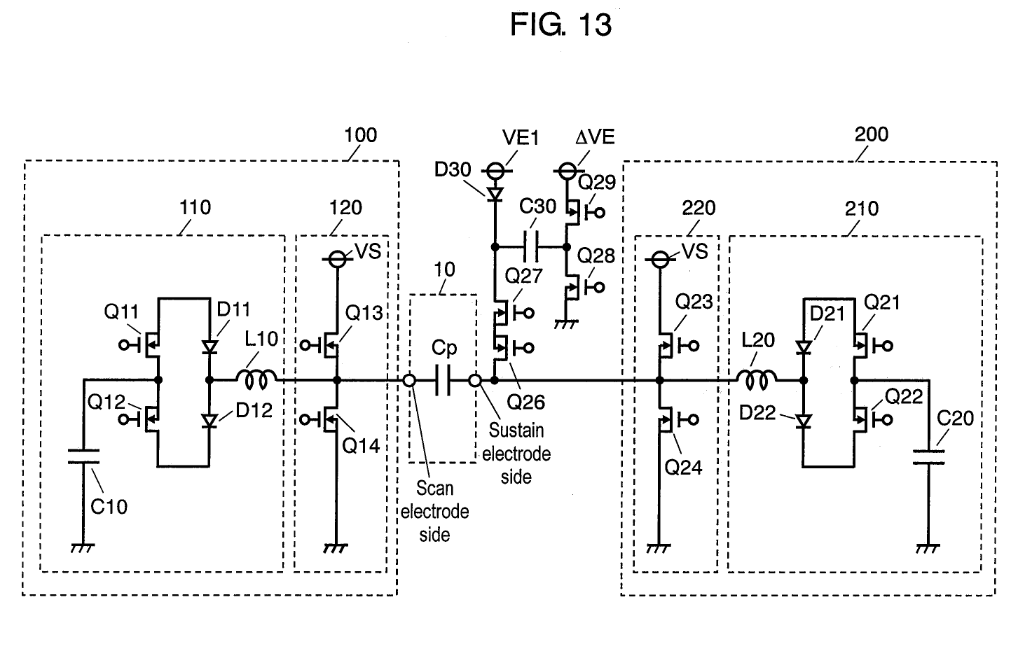

Next, details and operations of sustain pulse generating circuit 100 and sustain pulse generating circuit 200 will be described. FIG. 13 is a circuit diagram illustrating sustain pulse generating circuit 100 and sustain pulse generating circuit 200 according to the embodiment of the invention. In FIG. 13, an interelectrode capacitance of the panel 10 is denoted by Cp and circuits for generating the scan pulse and the initializing voltage waveform are omitted.

Sustain pulse generating circuit 100 includes power recovering section 110 and clamp section 120. Power recovering section 110 includes power recovering capacitor C10, switching elements Q11 and Q12, reverse-current preventing diode D11, diode D12, and resonating inductor L10. Clamp section 120 includes switching element Q13 for clamping scan electrodes SC1 to SCn to power source VS with a voltage value of Vs and switching element Q14 for clamping scan electrodes SC1 to SCn to a ground potential. Power recovering section 110 and clamp section 120 are connected to scan electrodes SC1 to SCn which are an end of interelectrode capacitance Cp of the panel 10 through a scan pulse generating circuit (not shown since it is short-circuited in the sustain period).

Power recovering section 110 allows interelectrode capacitance Cp and inductor L10 to resonate in an LC resonating manner so as to raise and lower the sustain pulse. When the sustain pulse rises, the charges accumulated in power recovering capacitor C10 are made to move to interelectrode capacitance Cp through switching element Q11, diode D11, and inductor L10. When the sustain pulse falls, the charges accumulated in interelectrode capacitance Cp are made to return to power recovering capacitor C10 through inductor L10, diode D12, and switching element Q12. In this way, the sustain pulse is applied to scan electrodes SC1 to SCn. Since power recovering section 110 drives scan electrodes SC1 to SCn by the use of the LC resonance without any supply of power from the power source, power consumption is ideally 0. Power recovering capacitor C10 has sufficiently greater capacitance than that of interelectrode capacitance Cp and is filled with about Vs/2 which is a half of the voltage value Vs of power source VS so as to serve as a power source of power recovering section 110.

Voltage clamp section 120 connects scan electrodes SC1 to SCn to power source VS through switching element Q13 to clamp scan electrodes SC1 to SCn to voltage Vs and connects scan electrodes SC1 to SCn to the ground potential through switching element Q14 to clamp the scan electrodes to 0 (V). Voltage clamp section 120 drives scan electrodes SC1 to SCn in this way. Accordingly, impedance at the time of applying a voltage to voltage clamp circuit 120 is small and thus it is possible to allow large discharge current due to a strong sustain discharge to stably flow.

In this way, by controlling switching element Q11, switching element Q12, switching element Q13, and switching element Q14, sustain pulse generating circuit 100 applies the sustain pulse to scan electrodes SC1 to SCn by the use of power recovering section 110 and voltage clamp section 120. The switching elements can be constructed by generally known elements such as MOSFET or IGBT.

Sustain pulse generating circuit 200 includes power recovering section 210 having power recovering capacitor C20, switching element Q21, switching element Q22, reverse-current preventing diodes D21, diode D22, and resonating inductor L20 and clamp section 220 having switching element Q23 for clamping sustain electrodes SU1 to SUn to voltage Vs and switching element Q24 for clamping sustain electrodes SU1 to SUn to the ground potential and is connected to sustain electrodes SU1 to SUn which are an end of interelectrode capacitance Cp of panel 10. The operations of sustain pulse generating circuit 200 is the same as sustain pulse generating circuit 100 and thus its description will be omitted.

In FIG. 13, power source VE1 for generating voltage Ve1 for reducing the interelectrode potential difference of the display electrode pairs, switching element Q26 and switching element Q27 for applying voltage Ve1 to sustain electrodes SU to SUn, power source ΔVE for generating voltage ΔVe, reverse-current preventing diode D30, capacitor C30, and switching element Q28 and switching element Q29 for adding voltage ΔVe to voltage Ve1 to obtain voltage Ve2 are shown together. For example, at the time for applying voltage ve1 shown in FIG. 4, switching element Q26 and switching element Q27 are turned on to apply positive voltage Ve1 to sustain electrodes SU1 to SUn through diode D30, switching element Q26, and switching element Q27. At this time, by turning on switching element Q28, capacitor C30 is filled so that the voltage is equal to voltage Ve1. At the time for applying voltage Ve2 shown in FIG. 4, switching element Q28 is turned off while switching element Q26 and switching element Q27 are turned on. At this time, by turning on switching element Q29, voltage ΔVe is added to the voltage of capacitor C30 and Ve1+ΔVe, that is, voltage Ve2, to sustain electrodes SU1 to SUn. At this time, the current from capacitor C30 to power source VE1 is prevented by means of the function of diode D30.

The LC resonance period of inductor L10 of power recovering section 110 and interelectrode capacitance Cp of panel 10 and the LC resonance period (hereinafter, referred to as “resonance period”) of inductor L20 of power recovering section 210 and interelectrode capacitance Cp can be calculated from “2π(LCp)^{1/2}” when it is assumed that inductance of inductor L10 and inductance of inductor L20 are L. In this embodiment, inductor L10 and inductor L20 are set so that the resonance period of power recovering section 110 and power recovering section 210 is about 1100 nsec. The numerical values are only examples of this embodiment and it is preferable that the optimal values is set depending on the characteristics of the panel or the specifications of the plasma display device.

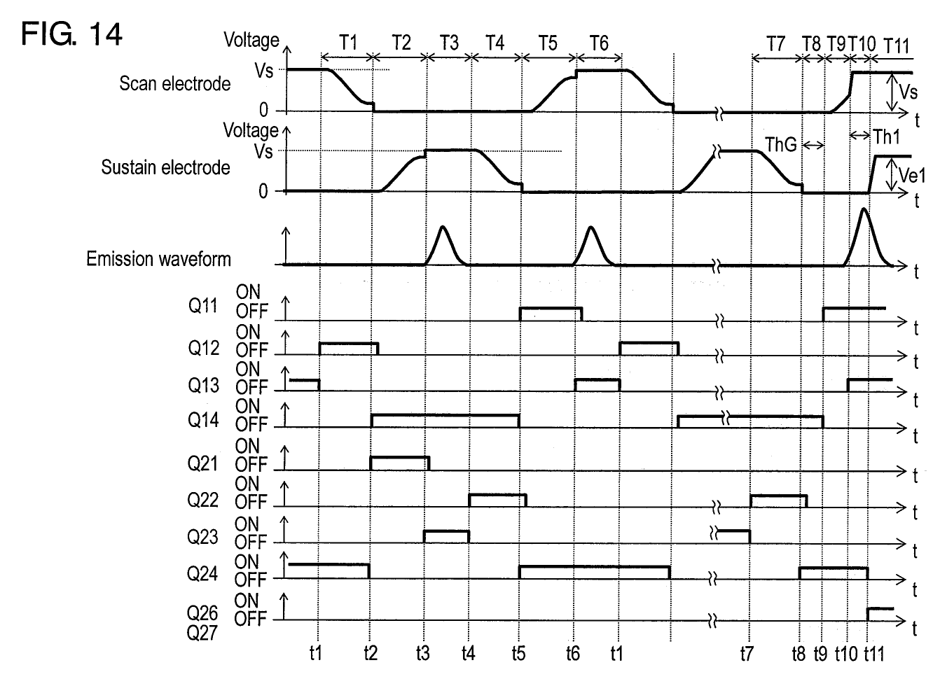

Next, details of the driving voltage waveforms in the sustain period will be described. FIG. 14 is a timing diagram illustrating operations of sustain pulse generating circuits 100 and 200 of the plasma display device according to the first embodiment of the invention and shows details of the portion surrounded by a dotted line in FIG. 4. First, one period of a sustain pulse is divided into six periods of T1 to T6 and then the respective periods will be described.

In the following description, the operation of turning on a switching element is called turn-on and the operation of turning off a switching element is called turn-off. In the drawings, a signal for turning on a switching element is marked as “ON” and a signal for turning off a switching element is marked as “OFF.”

(Period T1)

At time t1, switching element Q12 is turned on. Then, charges of scan electrodes SC1 to SCn starts flowing to capacitor C10 through inductor L10, diode D12, and switching element Q12 and thus the voltage of scan electrodes SC1 to SCn starts falling down. Since inductor L10 and interelectrode capacitance Cp form a resonance circuit, the voltage of scan electrodes SC1 to SCn at time t2 after ½ of the resonance period passes goes down to the vicinity of 0 V. However, the voltage of scan electrodes SC1 to SCn does not go down to 0 V due to the power loss resulting from a resistive component of the resonance circuit. In the meantime, switching element Q24 is kept in the ON state.

(Period T2)

At time t2, switching element Q14 is turned on. Since scan electrodes SC1 to SCn is connected directly to the ground through switching element Q14, the voltage of scan electrodes SC1 to SCn forcibly goes down to 0 (V).

At time t2, switching element Q21 is turned on. Then, current starts flowing from power recovering capacitor C20 through switching element Q21, diode D21, and inductor L20 and the voltage of sustain electrodes SU1 to SUn starts going up. Since inductor L20 and interelectrode capacitance Cp form a resonance circuit, the voltage of sustain electrodes SU1 to SUn at time t3 after ½ of the resonance period passes goes up to the vicinity of Vs. However, the voltage of sustain electrodes SU1 to SUn does not go up to Vs due to the power loss resulting from the resistive component of the resonance circuit.

(Period T3)

At time t3, switching element Q23 is turned on. Then, since sustain electrodes SU1 to SUn are connected directly to power source VS through switching element Q23, the voltage of sustain electrodes SU1 to SUn forcibly goes up to Vs. Then, in the discharge cells having generated the address discharge, the voltage between scan electrode SC1 to SCn and sustain electrode SU1 to SUn exceeds the breakdown voltage and thus the sustain discharge is generated.

(Periods T4 to T6)

Since the sustain pulse applied to scan electrodes SC1 to SCn and the sustain pulse applied to sustain electrodes SU1 to SUn have the same waveform, the operations of periods T4 to T6 are equivalent to the operations of period T1 to T3, that scan electrodes SC1 to SCn and sustain electrodes SU1 to SUn are replaced with each other and driven, and thus its description is omitted.

Switching element Q12 is turned off from time t2 to time t5 and switching element Q21 is turned off from time t3 to time t4. Switching element Q22 is turned off from time t5 to time t2 and switching element Q11 is turned off from t6 to time t1. In order to decrease the output impedance of sustain pulse generating circuit 100 and sustain pulse generating circuit 200, it is preferable that switching element Q24 is turned off just before time t2 and switching element Q13 is turned off just before time t4. It is also preferable that switching element Q14 is turned off just before time t5 and switching element Q23 is turned off just before time t4.

In the sustain period, the operations of periods T1 to T6 are repeated by the necessary number of pulses. In this way, the sustain pulse varying from 0 V as the base potential to voltage Vs as the potential for generating the sustain discharge is alternately applied to the display electrode pairs, thereby allowing the discharge cells to generate the sustain discharge.

Next, the final erasing discharge in the sustain period will be described in detail into five periods of T7 to T11.

(Period T7)

This period is equal to period T4, in which the sustain pulse applied to sustain electrodes SU1 to SUn goes down. That is, by turning off switching element Q23 just before time t7 and turning on switching element Q22 at time t7, the charges of sustain electrodes SU1 to SUn start flowing to capacitor C20 through inductor L20, diode D22, and switching element Q22 and the voltage of sustain electrodes SU1 to SUn starts going down.

(Period T8)

By turning on switching element Q24 at time t8, the voltage of sustain electrodes SU1 to SUn is forcibly made to go down to 0 V. Since switching element Q14 is kept on from period T7 and thus the voltage of scan electrodes SC1 to SCn is kept at 0 V, display electrode pairs, that is, scan electrodes SC1 to SCn and sustain electrodes SU1 to SUn, are kept to ground voltage 0 (V) as the base potential in period T8.

In this way, a period for clamping display electrode pairs to base potential 0 V and setting both electrodes of display electrode pairs to the base potential is disposed between the sustain pulse for generating the final sustain discharge and the previous sustain pulse and this period is used as ground period ThG.

(Period T9)

By turning off switching element Q14 just before time t9 and turning on switching element Q11 at time t9, current start flowing from power recovering capacitor C10 through switching element Q11, diode D11, and inductor L10 and the voltage of scan electrodes SC1 to SCn starts going up.

(Period T10)

Since inductor L10 and interelectrode capacitance Cp form a resonance circuit, the voltage of scan electrodes SC1 to SCn goes up to the vicinity of Vs after ½ of the resonance period passes. However, in this case, switching element Q13 is turned on in a period shorter than ½ of the resonance period of the power recovering section, that is, at time t10 before the voltage of scan electrodes SC1 to SCn goes up to the vicinity of Vs. Then, since scan electrodes SC1 to SCn are connected directly to power source VS through switching element Q13, the voltage of scan electrodes SC1 to SCn goes up to Vs rapidly, thereby generating the final sustain discharge.

(Period T11)

Switching element Q24 is turned off just before time t11 and switching element Q26 and switching element Q27 are turned on at time t11. Then, since sustain electrodes SU1 to SUn are connected directly to erasing power source VE1 through switching elements Q28 and Q29, the voltage of sustain electrodes SU1 to SUn is forcibly made to go up to Ve1. Time t11 is a time before the discharge generated in period T10 is over, that is, a time when charged particles generated by the discharge are sufficiently left in the discharge space. Since the electric field in the discharge space is changed while the charged particles are sufficiently left in the discharge space, the charged particles are re-arranged so as to alleviate the changed electric field, thereby forming wall charges.

At this time, since a voltage difference between scan electrodes SC to SCn and sustain electrodes SU1 to SUn is reduced by applying voltage Ve1 to sustain electrodes SU1 to SUn, the wall voltages on scan electrodes SC1 to SCn and sustain electrodes SU1 to SUn are weakened. In this way, the potential difference for generating the final sustain discharge is a potential difference of a narrow pulse shape adjusted so as to alleviate the potential difference applied across the display electrode pairs before the final sustain discharge is over, and the generated sustain discharge is an erasing discharge. Although not shown in FIG. 14, since data electrodes D1 to Dm are kept at 0 V and the charged particles form wall charges so as to alleviate a potential difference between the voltage applied to data electrodes D1 to Dm and the voltage applied to scan electrodes SC to SCn, a positive wall voltage is formed on data electrodes D1 to Dm. Voltage Ve1 is set to be smaller than voltage Vs so that the polarities of the wall charges of scan electrodes SC1 to SCn and sustain electrodes SU1 to SUn.

In this way, a predetermined time period is disposed between the time point when the sustain pulse for generating the final sustain discharge is applied to one of the display electrode pairs (scan electrodes SC1 to SCn) and the time point when the voltage for reducing the interelectrode potential difference of the display electrode pairs is applied to the other of the display electrode pairs (sustain electrodes SU1 to SUn) and the time period is used as erasing phase difference Th1.

In this embodiment, in the time period (100 nsec or 150 nsec in this embodiment) corresponding to the lighting ratio of the discharge cells in the subfield after switching element Q13 for applying voltage Vs for generating the sustain discharge to scan electrodes SC1 to SCn, the control is made by turning on switching element Q26 and switching element Q27 for applying to sustain electrodes SU1 to SUn voltage Ve1 for reducing the interelectrode potential difference of the display electrode pairs. Accordingly, until the switching elements actually starts their switching operations after control signals are input to the switching elements, a delay occurs due to a delay time of the switching elements, but the time gap of the control signals input to the switching elements, that is, from time t10 to time t11, can be considered as erasing phase difference Th1.

The circuits for applying voltage Ve1 and voltage Ve2 are not limited to the circuit shown in FIG. 13, but the voltages may be applied to sustain electrodes SU1 to SUn at necessary times by the use of the power source for generating voltage Ve1, the power source for generating voltage Ve2, and plural switching elements for applying the voltages to sustain electrodes SU1 to SUn.

The numerical values described in this embodiment, that is, the numerical values such as the first threshold value and the second threshold value used for comparison with the lighting ratio, erasing phase difference Th1, and ground period ThG are based on the characteristics of the 50-inch panel with 1080 display electrode pairs and show only examples thereof. The optimal values may be preferably set depending on the characteristics of the panel or specifications of the plasma display device.

Although the subfield configuration that the first SF is the overall cell initializing subfield and the second SF to the tenth SF are the selective initializing subfield has been described in the embodiment of the invention, the invention is not limited to the subfield configuration, but may have another subfield.

Although it has been described in this embodiment that the same inductor is used for power supply and for power recovering, the invention is not limited to such a configuration, but plural inductors having different inductance can be switched for use. In this configuration, for example, it is possible to change the resonance frequency for driving by the use of the rising and the falling of the sustain pulse.

It has been described in this embodiment that the ground potential is used as the base potential. However, in an AC panel, since the discharge cells are surrounded with dielectrics and the driving voltage waveforms of the electrodes are applied to the discharge cells in the capacitive manner, the driving voltage waveforms including the base potential may be shifted in level in the DC manner.

As described above, according to this embodiment, when the lighting ratio is high (when the lighting ratio is 55% or more), erasing phase difference Th1 is set to 150 nsec and ground period ThG is set to 0 μsec in all the subfields. When the lighting ratio is middle (when the lighting ratio is 25% or more and less than 55%), erasing phase difference Th1 is set to 150 nsec and ground period ThG is set to 0.5 μsec in all the subfields. When the lighting ratio is low (when the lighting ratio is less than 25%), erasing phase difference Th1 is set to 100 nsec and ground period ThG is set to 0 μsec in only the subfields (the fourth SF to the tenth SF) having a predetermined brightness weight (brightness weight of “5”). In the subfields (the first SF to third SF) having a brightness weight less than it, erasing phase difference Th1 is not set to 100 nsec and ground period ThG is not set to 0 μsec even when the lighting ratio is less than 25%, but erasing phase difference Th1 is set to 150 nsec and ground period ThG is set to 0.5 μsec, similarly to the case where the lighting ratio is 25% or more and less than 55%. Accordingly, it is possible to generate a stable address discharge without increasing the scan pulse voltage or the address pulse voltage necessary for generating the address discharge. In addition, it is possible to display an image low in APL with a smooth variation in gray scale.

### INDUSTRIAL APPLICABILITY

According to the invention, it is possible to generate a stable address discharge even in a panel having high precision, large screen size, and high brightness without increasing a voltage necessary for generating an address discharge. In addition, it is possible to display an image low in APL with a smooth variation in gray scale, thereby enhancing the image display quality. Accordingly, the invention can be suitably used for a plasma display device and a panel driving method.

1. A plasma display device comprising:
a plasma display panel that has a plurality of discharge cells having a plurality of scan electrodes and sustain electrodes which form display electrode pairs;
a driving circuit that drives the plasma display panel by forming a plurality of subfields in one field period, each of the subfields having an initializing period for generating an initializing discharge in the discharge cell, an address period for selectively generating an address discharge in the discharge cell, and a sustain period for generating a sustain discharge in the discharge cell selected in the address period a number of times corresponding to a brightness weight;
a lighting ratio calculating circuit that calculates a light ratio of the discharge cells every subfield,
wherein in the sustain period, the driving circuit alternately applies a sustain pulse varying from a base potential to a potential for generating the sustain discharge to the display electrode pairs,
forms a period for connecting the display electrode pairs to the base potential between a sustain pulse for generating the final sustain discharge and a previous sustain pulse,
applies a voltage for reducing an interelectrode potential difference of the display electrode pairs to the sustain electrodes in a predetermined time period after applying the sustain pulse for generating the final sustain discharge to the scan electrodes, and
changes at least one of the period for connecting the display electrode pairs to the base potential and the predetermined time period based on the lighting ratio calculated by the lighting ratio calculating circuit.

2. A plasma display panel driving method of driving a plasma display panel that has a plurality of discharge cells having a plurality of scan electrodes and sustain electrodes which form display electrode pairs, the method comprising:
forming a plurality of subfields in one field period, each of the subfields having an initializing period for generating an initializing discharge in the discharge cell, an address period for selectively generating an address discharge in the discharge cell, and a sustain period for generating a sustain discharge in the discharge cell selected in the address period a number of times corresponding to a brightness weight;
alternately applying a sustain pulse varying from a base potential to a potential for generating the sustain discharge to the display electrode pairs, in the sustain period;
forming a period for connecting the display electrode pairs to the base potential between a sustain pulse for generating the final sustain discharge and a previous sustain pulse;
applying a voltage for reducing an interelectrode potential difference of the display electrode pairs to the sustain electrodes in a predetermined time period after applying the sustain pulse for generating the final sustain discharge to the scan electrodes;
calculating a lighting ratio of the discharge cells every subfield; and
changing at least one of the period for connecting the display electrode pairs to the base potential and the predetermined time period based on the lighting ratio of the corresponding subfield.

3. (canceled)

4. (canceled)

5. (canceled)

6. (canceled)
